(19) United States
(12) Patent Application Publication
(10) Pub. No.: US 2016/0003283 A1
(43) Pub. Date: Jan. 7, 2016

(54) Steel stud anchor

(71) Applicants: Franklin Jiri Call, Pickering (CA); Mark Robbeson, Toronto (CA)

(72) Inventors: Franklin Jiri Call, Pickering (CA); Mark Robbeson, Toronto (CA)

(21) Appl. No.: 14/194,679

(22) Filed: Mar. 1, 2014

(51) Int. Cl. F16B 25/10; F16B 25/00

(52) U.S. Cl. CPC F16B 25/10; F16B 25/0021

(57) ABSTRACT

A metal anchoring fastener fastens millwork onto walls constructed with wall cladding fastened to steel studs. The load typical of a loaded cabinet is borne by the steel stud anchors owing to the mate between the profile of the steel stud anchor and the layers of millwork and wall cladding and steel stud that said anchor penetrates. The pitch of the thread adorning the profile of the steel stud anchor progresses non-linearly along the length of said shaft, the shaft is generally non-linear in profile, and the thread profile is non-uniform along the length of said shaft. The anchor can also support a secondary screw concentrically penetrating the void at the center of the anchor, in order to hang loads from a wall, with or without millwork. Predrilling of the holes can enable installation of these zinc anchors.

### FIELD OF THE INVENTION

This Invention relates generally to fasteners and more particularly to fasteners detailed to anchor in steel studs supporting walls in buildings.

### BACKGROUND OF THE INVENTION

This Application describes how the structure of the novel steel stud anchor fastener constituting the Invention alters millwork, wall cladding, and steel stud to form a load-bearing mate. “Millwork” refers to a plurality of wooden wall furnishings, including cabinets. “Wall cladding” refers to a plurality of generally planar materials fastened vertically to vertical support studs, exemplified by gypsum wallboard. “Steel studs” are vertical struts formed by the folding of sheet metal to resist bending. When fastened from floor to upper beam, said steel studs form walls to which wall cladding, generally gypsum wallboard, and millwork, such as cabinets, are applied. An “anchor” refers to a fastener that forms a mate with a substrate to bear a load. The “mate” refers to the piercing and threading into a substrate of the threaded fastener, also called “screw”, exemplified by a screw mated to a wall by driving it in with a screwdriver, manual or power-driven. “Linear” describes the relationship of a dependent variable increasing in a straight line function with an increase in the independent variable, “non-linear” refers to said relationship function described by a curve.

A plurality of threaded fasteners exist. Said fasteners are distinguished by “tightening features”, “shaft profile”, “thread pitch”, “thread profile”, “materials”, and terminal “piercing” and “cutting” features. “Tightening features” include a plurality of geometries into which a drive bit is fitted to enable rotation of the screw head, said screw head being a flanged accoutrement crowning a threaded shaft. The “shaft profile” itself describes the change of diameter of the shaft down the length of the shaft. Said shaft profile can be a meeting of two straight lines, a “linear” shaft, or two curves, a “non-linear” shaft. Generally conical shafts equipped with helical threads will translate a rotational force applied to the head into a perpendicular linear displacement into the material to which the fastener is applied. The “thread pitch” describes the number of rotations of the thread per linear unit of shaft length. An “aggressive” thread has a widely spaced helical ridge. Thread can be “linear”, that is, unchanging along the length of the shaft, or “non-linear”, wherein the thread count varies along the long axis of the fastener shaft. “Thread profile”, the cross-sectional shape and dimensions of the thread ridge as it winds around the shaft, can be uniform or non-uniform along the thread helix. Changing thread pitch and thread profile along the shaft can result in different qualities of mate between the fastener and the material being fastened into. The choice of “materials” can affect the hardness, brittleness, and tensile strength of the fastener, all of which will determine the quality of the mate with the substrate into which the fastener is fastened. Finally, at the terminal point of the shaft a plurality of “cutting” features and “piercing” features can be incorporated to add the entry of the fastener into the substrate. Said cutting and piercing features are affected by materials and geometry. In this Application, the metal alloy described is zinc, hardened by the Iosso hardening process, allowing for diecasting of the fasteners instead of machining as necessary with stainless steel fasteners. This Application describes an Invention in which these variables are configured such that the resulting fastener provides an anchor in steel studs when said fastener is drilled into a layering of millwork, wall cladding, and steel stud. Predrilling a hole is also possible.

Lopez (U.S. Pat. No. 4,473,984: Oct. 2, 1984) presents a threaded stud that is meant to penetrate any masonry, wood, or steel stud wall to present a loop transverse to the stud thread helix emanating from the wall said threaded stud has penetrated. While no claims or description are made of the threaded stud, the patent specification does identify that the manner of thread and cutters can influence the thread mate. Diagrams for this patent indicate a threaded stud or shaft that is identical in cross-section from base to just before the conical pointed tip. Non-linear shaft profiles, non-linear thread pitch progressions, non-uniform progression of thread profile are all not discussed in terms of their influence on mate between the anchor and the wall. Bui (U.S. Pat. No. 8,601,763: Dec. 10, 2013) describes a novelty specific to the metal studs discussed in this Application. Bui describes a rivet to be applied between ribs of a steel stud into screws supported a concrete panel can be drilled. This static implementation of a mate in the steel stud itself presupposes the ability to find this mate rivet when hanging the wall cladding to the steel studs.

Katsumi (U.S. Pat. Appln. 20060228186: Oct. 12, 2006) presents a self-tapping stainless steel screw with a built-in fracture line to remove the drill head when drilling steel sheets for rooves and walls. What the steel sheets are being affixed to is not specified. No special attention is given to the thread, the thread profile, and the shaft profile, and the material used is not zinc.

### SUMMARY OF THE INVENTION

Accordingly, it is an objection of this invention to at least partially overcome some of the disadvantages of the prior art.

The present arrangement utilizes a helically threaded generally conical fastener equipped with tightening features in the head and piercing features in the point that enable the fastener to be drilled through a wall and anchor to the steel stud supporting said wall. Pre-drilling a hole in preparation to drilling the anchor into the wall is also an installation option for this anchor.

More particularly, a fastener is provided for anchoring perpendicularly into vertical steel studs supporting wall cladding, and, optionally, millwork. The fastener has a head equipped with tightening features arranged around an inner void. Said tightening features can be temporarily coupled to a complementary drive shaft in order to drive said fastener into the wall. During this penetration of the fastener into the substrate, the helical thread winding around the generally conical fastener shaft translates the rotary motion applied to the fastener head by the drill into a linear translation of the anchor toward the steel stud supporting the wall substrate of wall cladding and millwork. A piercing point at the narrow point of the fastener distal to the head causes the steel stud, when reached, to be pierced and allows the thread to fold over the metal to form a rigid anchor between the thread of the shaft with the newly rimmed perforation in the steel stud. Said penetration of said steel stud may be aided by predrilling of a hole prior to drilling in of the said anchor.

In a preferred embodiment, a wall is prepared by fixing steel studs at top and bottom to form a structure onto which wall cladding can be fixed. Wall cladding is attached to the steel stud by means of conventional fasteners. Using a power driver equipped with a bit that matches the tightening features of the fastener head, the fastener is driven through the back wall of millwork such as a cabinet, through the wall cladding, and piercing the steel stud to form a mate that bears load such as a loaded cabinet.

The anchor may be further pierced through the head by a secondary ordinary fastening screw to provide an anchor within an anchor.

### BRIEF DESCRIPTION OF THE DRAWINGS

In the drawings, which illustrate embodiments of the invention:

FIG. 1 shows a perspective front view of millwork fastened to a steel stud wall by steel stud anchors;

FIG. 2 shows a steel stud anchor in isometric view;

FIG. 3(a) is a top view of the steel stud anchor;

FIG. 3(b) is a cross-sectional view of the anchor of FIG. 3(a) along line C-C′;

FIG. 4(a) is a top view of the anchor penetrated by a secondary screw;

FIG. 4(b) is a cross-sectional view of the anchor and screw of FIG. 4(a) along line D-D′;

FIG. 5(a) is a cross-sectional side view showing penetration of the anchor into the millwork and wall cladding;

FIG. 5(b) is a portion of the view of the rim formed in the steel stud wall of FIG. 5(a) enlarged for magnification purposes.

### DETAILED DESCRIPTION OF THE INVENTION

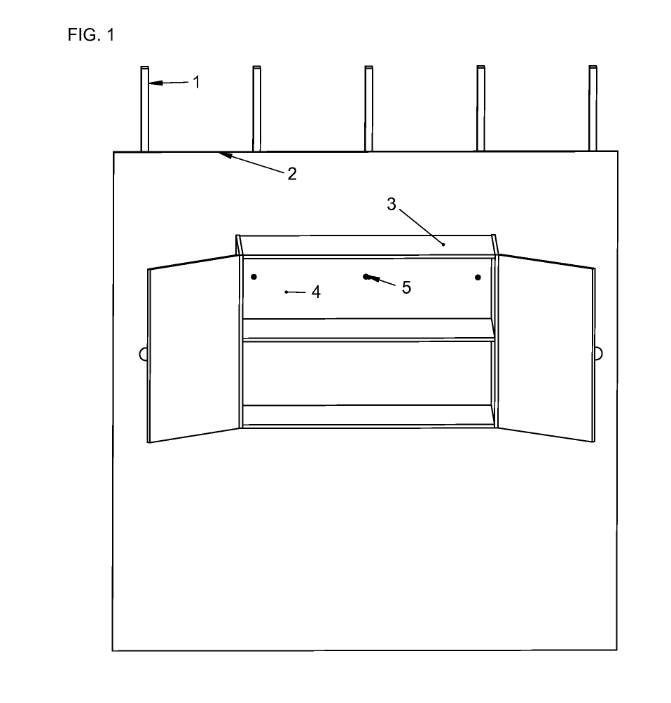

FIG. 1 shows an isometric view of millwork 3 fastened to a steel stud wall, showing steel studs 1 vertically arranged in a generally regular spacing, and supporting wall cladding 2. Steel stud anchors 5 penetrate the back board 4 of the millwork 3, the rear plane of said backboard being contiguous with the generally vertical plane of the wall cladding 2. In this fashion, the millwork may bear a specific load, exemplified by a kitchen cabinet full of dishes. The load variable is a function of the wall material, the gauge of the metal stud 1, and the metal comprising the steel stud anchor 5.

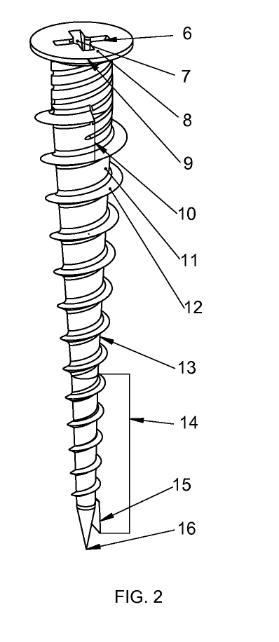

In FIG. 2, an anchor is shown in isometric view with a central void 6 surrounded by Philips tightening features 7 in the head 8 bearing a flange 9. A thread 12 with a variable pitch 10 adorns the shaft 11, the profile 13 of the shaft 11 having an auger zone 14 nearer the cutting blade 15 and piercing tip 16.

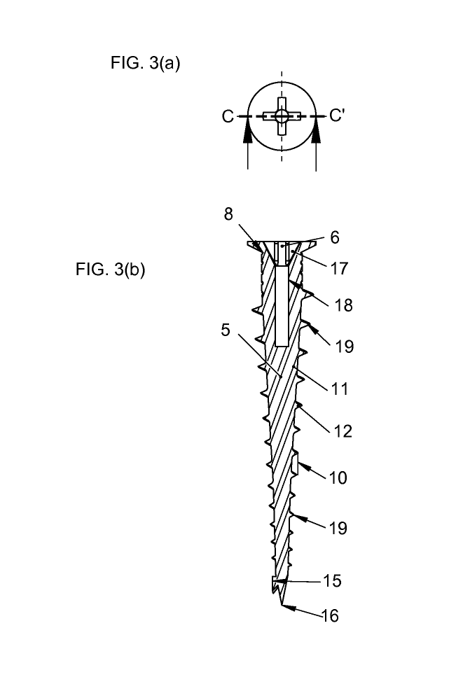

In FIG. 3(a), a top view of the steel stud anchor 5 is shown and cross-sectioned to reveal the inner profile of the anchor in FIG. 3(b). A vertical cross-section of the top view reveals a tightening end or head 8 containing a void 6 defined by a bore wall 18 equipped with tightening features 17 along a portion of the void 6. A cutting thread 12 with non-linear pitch 10 adorns the anchor shaft 11. The shaft itself has a non-linear progression of diameter along the shaft 11; similarly the thread profile 19 varies along the length of the shaft. A cutting blade 15 located on the end of the shaft 11 near the piercing point 16 cuts and scoops away detritus, and the piercing point 16 is able to penetrate the steel stud.

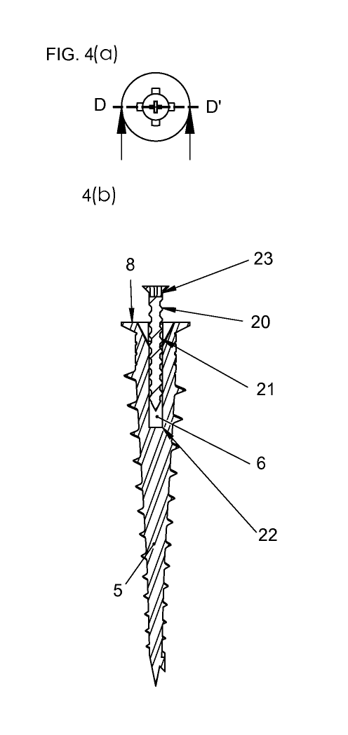

FIG. 4(a) is a top view cross-sectioned to form FIG. 4(b) of the anchor 5 penetrated by a secondary screw 20 and in which the details of the mating of these two pieces is illustrated. The steel stud anchor 5 can anchor in a steel stud wall, with or without intervening millwork, to form wall anchors upon which objects may be hung, for example, a painting, by threadeningly penetrating the void 6 formed in the head 8 of the steel stud anchor 5 with a secondary screw 20 with a thread 21 to form a load-bearing thread mate. The travel of the secondary screw 20 within the anchor 5 is limited by the depth 22 of the anchor void 6, or by collision of the secondary screw head 23 with the head 8 of the steel stud anchor 5.

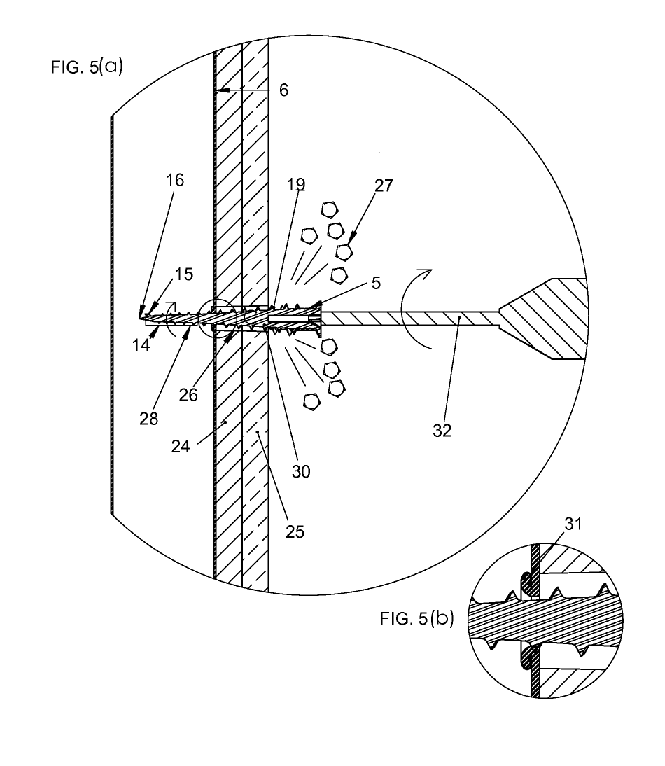

In the lateral cross-section presented in FIG. 5, penetration of the millwork surface 30 to make a perforation 26 by the anchor 5 into the millwork 25 and wall cladding 24 results in loose detritus 27. Alternately, said perforation can be pre-drilled. Said detritus 27 is augered out and away from the conical perforation 26 in the millwork 25 and the wall cladding 24, preventing overpacking of the resulting mate. Said overpacking can result in an undesirable bulge that separates the millwork 25 from the wall cladding 24 to which said millwork is supposed to be contiguous. The steel stud anchor comprises an auger zone 14 proximal to the anchor tip 16, and a wedge zone 28 distal to the tip 16. A power drill 32 provides the driving power. In FIG. 5(b), the bending back of the stainless steel sheet folded into the stud is shown in detail, where a rim 31 can be seen to be formed under the influence of the attack. Said rim reinforces said mate.

In certain embodiments, the steel stud anchor 5 may have a pressfit finishing cap.

1. An anchoring metal fastener comprising a fastener head and a shaft:
a fastener head equipped with tightening features around a central void.
a threaded, generally conical shaft with curved sides in cross-section that meet at a tip.
a non-linear progression in thread pitch along the length of the shaft.
a thread profile that changes with position along the thread.
a non-linear progression of shaft diameter along the length of the shaft.
a piercing point at the distal end of the generally conical shaft.

2. An anchoring metal fastener as claimed in claim 1 where the fastener is concentrically penetrated by a generally conical cavity partly extruding into the shaft from the head of the fastener, into said cavity a secondary screw may be threaded.

3. An anchoring metal fastener shaft as claimed in claim 1 manufactured by a Iosso hardened zinc metal alloy that provides sufficient strength at the piercing point at the free end of the fastener to pierce a given thickness of sheet steel from which the steel stud is constructed.

4. An anchoring metal fastener shaft as claimed in claim 1 manufactured by a Iosso hardened zinc metal alloy that provides sufficient strength to a rectangular cutter blade located generally perpendicular to the axis of the shaft and located on the thread proximal to the point at the piercing point to bore into a matched thickness of sheet steel from which the steel stud is constructed.
